(19) United States
(12) Patent Application Publication
(10) Pub. No.: US 2018/0164126 A1
(43) Pub. Date: Jun. 14, 2018

(54) METHOD OF ROLL CALIBRATION FOR A WORK VEHICLE

(71) Applicant: CNH Industrial America LLC, New Holland, PA (US)

(72) Inventors: William L. Schubert, Downers Grove, IL (US); Todd S. Aznavorian, Naperville, IL (US)

(73) Assignee: CNH Industrial America LLC, New Holland, PA (US)

(21) Appl. No.: 15/375,957

(22) Filed: Dec. 12, 2016

(51) Int. Cl. G01C 25/00

(52) U.S. Cl. CPC G01C 25/005

(57) ABSTRACT

A method of calibrating a roll angle associated with a work vehicle includes the steps of: positioning the vehicle on a substantially level surface in a first direction; taking a first calibration reading, by using an inertial measurement unit (IMU) to measure a roll of the vehicle while the vehicle is in a first of a sequence of calibration maneuvers in the first direction; positioning the vehicle on the substantially level surface in a second direction, generally opposite the first direction; taking a second calibration reading, by using the IMU to measure a roll of the vehicle while the vehicle is in a second of the sequence of calibration maneuvers in the second direction; and reconciling the first calibration reading and the second calibration reading to determine a calibrated roll angle of the vehicle.

### BACKGROUND OF THE INVENTION

### 1. Field of the Invention

The present invention relates to work vehicles, and, more particularly, to work vehicles equipped with an auto-guidance system.

### 2. Description of the Related Art

Work vehicles can generally be thought of as vehicles which are primarily equipped to do functional work. Such work vehicles can typically be found in the agricultural, construction, industrial and forestry technology sectors. For example, an agricultural harvester is used to harvest grain, a backhoe or excavator (also known as a track hoe) are used to dig and move dirt, a front end loader is used to pick up and move various types of material, depending on the type of attachment at the front end, a swather is used to cut and windrow crop, a crane is used to pick up and move heavy loads, and a feller/buncher is used to cut down, cut to length, stack and move trees. There are also many other types of work vehicles in these technology sectors.

In recent years, work vehicles have more commonly been equipped with an auto-guidance (AG) system, which automatically drives the vehicle on a predefined path through a geographic area such as a field. The AG system can be autonomous or semi-autonomous. In the case of a semi-autonomous AG system, an operator rides in the operator cab and can take over manual operation of the vehicle, if needed or desired. In the case of an autonomous AG system, no operator is present in the vehicle.

Such vehicles are typically equipped with a geo-reference unit (GRU), such as a global positioning system (GPS). The work vehicle can also include other types of electronic equipment which can be relevant to and work in conjunction with the AG system, such as an Inertial Measurement Unit (IMU), etc. An IMU can measure the roll angle, pitch angle, yaw angle, acceleration, etc. of the vehicle. The various electronic systems associated with the AG system are typically connected and in communication with a Vehicle Control Unit (VCU) via a CAN bus, wireless link, or the like.

While traversing the geographic area using an AG system, the roll angle of the vehicle to a horizontal or vertical reference can be relevant. For example, the GPS unit may not be positioned at the center of the vehicle longitudinal axis (i.e., the GPS may be offset relative to the centerline of the vehicle), and it may be desirable to position the vehicle such that a towed implement is positioned accurately relative to a previous swath of the implement. The roll angle of the vehicle can further affect the actual position of the GPS unit, relative to a theoretical centerline of the vehicle. Thus, it may be desirable to know the offset of the GPS unit relative to the vehicle centerline, the roll angle of the vehicle, etc. to accurately position the vehicle and attached implement during operation of the vehicle using AG.

What is needed in the art is a work vehicle that may be operated with AG, which takes into account the roll angle of the vehicle for accurately carrying out AG operations.

### SUMMARY OF THE INVENTION

The present invention provides a method of calibrating a roll angle on a work vehicle in which the vehicle is engaged in a first of a sequence of calibration maneuvers in a first direction, reversed in an opposite second direction, and then engaged in a second of a sequence of calibration maneuvers in the second direction.

The invention in one form is directed to a method of calibrating a roll angle associated with a work vehicle having a GRU and an IMU. The method includes the steps of: positioning the vehicle on a substantially level surface in a first direction; taking a first calibration reading, by using the IMU to measure a roll of the vehicle while the vehicle is in a first of a sequence of calibration maneuvers in the first direction; positioning the vehicle on the substantially level surface in a second direction, generally opposite the first direction; taking a second calibration reading, by using the IMU to measure a roll of the vehicle while the vehicle is in a second of the sequence of calibration maneuvers in the second direction; and reconciling the first calibration reading and the second calibration reading to determine a calibrated roll angle of the vehicle.

An advantage of the present invention is that an off track correction factor for the roll angle can be determined, based on the error of the roll angle in opposite directions of the vehicle.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic rear view of a work vehicle in the form of a tractor, showing the GPS unit and various relevant angles associated with the operation of the tractor;

FIG. 2 is a top schematic view of the tractor shown in FIG. 1;

FIG. 3 is an overhead schematic representation of another embodiment of a sequence of calibration maneuvers (corresponding to a straight line) which can be used with the calibration method of the present invention; and

FIG. 4 is an overhead schematic representation of yet another embodiment of a sequence of calibration maneuvers (corresponding to a circle) which can be used with the calibration method of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

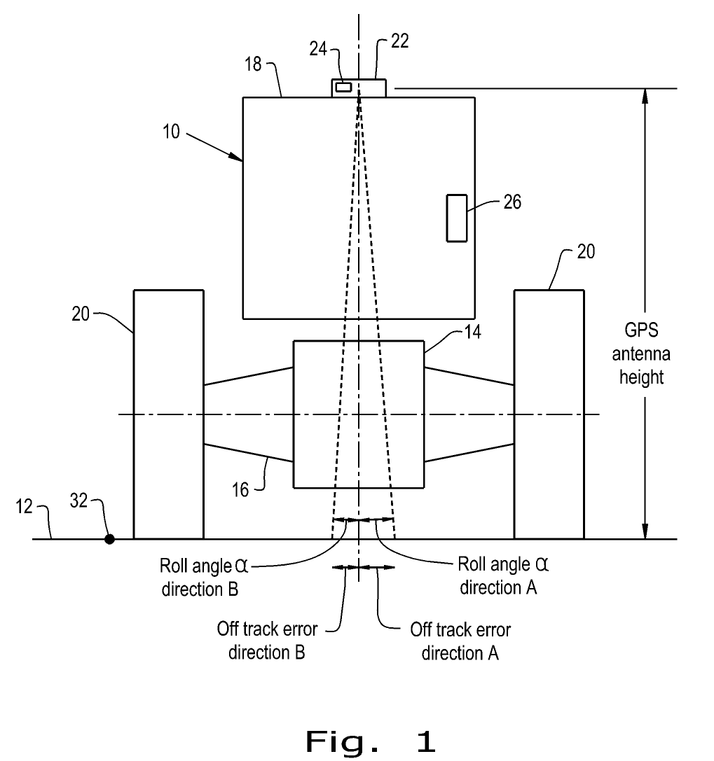

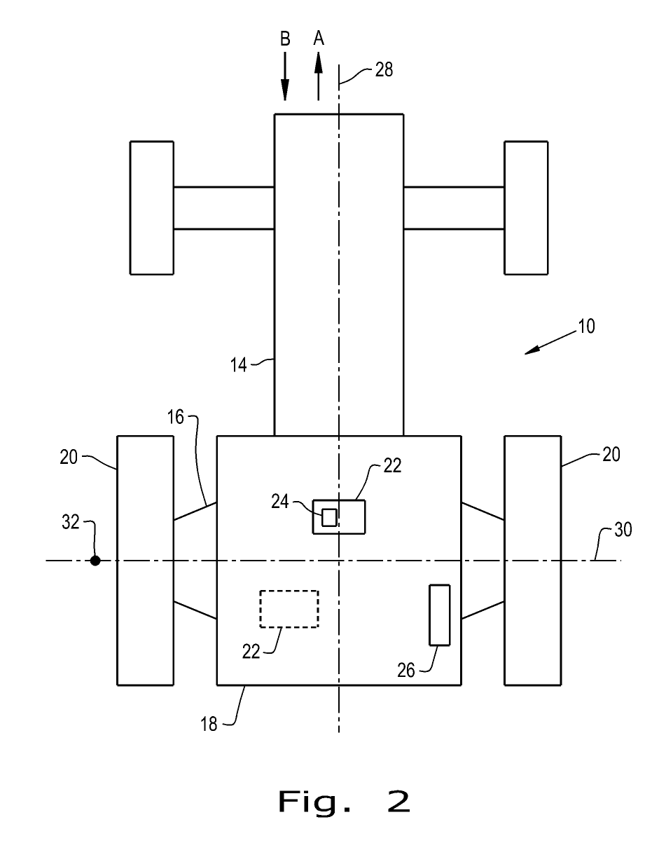

Referring now to the drawings, and more particularly to FIGS. 1 and 2, there are shown schematic rear and top views, respectively, of a work vehicle in the form of an agricultural tractor 10 which is positioned on a generally level (i.e., horizontal) ground surface 12. Although shown as an agricultural work vehicle in the form of a tractor, the work vehicle could also be differently configured, such as an industrial work vehicle (e.g., skid loader), a construction work vehicle (e.g., backhoe) or a forestry work vehicle (e.g., feller buncher).

Tractor 10 generally includes a chassis 14 which carries most structural components of the tractor, such as the rear axle 16, operator cab 18, engine compartment (visible in FIG. 2), etc. The tractor also includes ground engaging members such as the rear wheels 20 at the outboard ends of the rear axle 16, or track or half tracks (not shown).

A GRU 22 is usually positioned at the top of the operator cab on a tractor equipped with AG. In the USA, the GRU is typically configured as a GPS unit, while in other parts of the world the exact configuration of the GRU can vary. The GPS unit may include the IMU 24, or the IMU can be separate from the GPS unit. The IMU is configured to measure predetermined dynamic criteria associated with tractor 10 while it is in operation, such as the roll angle, pitch angle, yaw angle, acceleration, etc. of the vehicle as it moves across the ground surface 12.

The GRU can communicate with a Vehicle Control Unit (VCU) 26, which in the illustrated embodiment is located in the console region within the operator cab 18. The GRU, including the GPS and IMU, can be coupled with the VCU 26 via a CAN buss, wireless connection, etc (not shown). In the illustrated embodiment, the VCU 26 is configured as a digital controller, but could also be configured as an analog or hardwired processor or an Application Specific Integrated Circuit (ASIC).

The GRU 22, including the GPS unit and the IMU 24, can be positioned at a known location on top of the operator cab 18. The tractor 10 includes a theoretical longitudinal axis 28 and a lateral axis 30 which extends through the rear axle 16. The GRU 22 can be positioned at a known location relative to the longitudinal axis 28 and lateral axis 30. For example, the GRU 22 can be positioned in line with the longitudinal axis 28 (side-to-side), and forward of the lateral axis 30 (front to back), as shown in FIG. 2. Alternatively, the GRU 22 can be positioned at another suitable location, such as to the left and rearward of the intersection of the longitudinal axis 28 and lateral axis 30, as shown in dashed lines in FIG. 2.

As will be appreciated, the actual position of the GRU 22 relative to the longitudinal axis 28 and lateral axis 30 must be taken into account when determining the actual position of the tractor 10 or an attached towed implement (not shown). For example, if the GRU 22 is positioned offset relative to the longitudinal axis 28, and it is desired to position a number of rows units on a towed implement at precise locations relative to a previous swath of the implement, then the lateral offset of the GRU 22 must be taken into account in the AG algorithm.

Moreover, the roll angle of the tractor 10 (or other work vehicle, as the case may be) must be taken into account when determining the actual position of the tractor 10 or an attached towed implement. Due to the offset of the GRU 22 relative to the longitudinal axis 28 and lateral axis 30, and the magnitude of the roll angle, the actual position of the GRU 22 will vary.

Referring to FIG. 1, the effect of the roll angle on the actual position of the GRU 22 is schematically illustrated, and a method of calibrating the roll angle of the tractor 10 will be described herein. The tractor will generally be referred to as a vehicle, as the calibration method can apply to other types of work vehicles.

The method of calibrating a roll angle associated with the vehicle 10 includes positioning the vehicle on a substantially level surface in a first direction A. The vehicle 10 is positioned such that that the rear axle (and lateral axis 30) is at a known location, represented by the point 32. After the vehicle 10 is positioned at the known point 32, a first calibration reading is taken using the IMU 24 to measure a roll angle α of the vehicle 10 while the vehicle 10 is in a first of a sequence of calibration maneuvers in the first direction A. Thus, the first of the sequence of calibration maneuvers includes driving the vehicle in a first direction, stopping the vehicle at a known reference location, and measuring the roll angle when the vehicle is heading in the first direction.

Then the vehicle 10 is turned around and headed in a direction B, which is generally opposite to direction A. The vehicle 10 is again positioned in the opposite direction B at the known location such that the rear axle (and lateral axis 30) aligns with the point 32. A second calibration reading is taken using the IMU 24 to measure a roll angle α of the vehicle 10 while the vehicle is parked at the point 32. Thus, the second of the sequence of calibration maneuvers includes driving the vehicle in a second direction B opposite to the direction A, stopping the vehicle at a known reference location, and measuring the roll angle when the vehicle is heading in the second direction.

The first calibration reading and the second calibration reading are then reconciled to determine a calibrated roll angle of the vehicle. To that end, the sequence of calibration maneuvers can be represented with mathematical expressions:

Roll angle α direction A*GPS antenna Height=Off track error direction A; a.

Roll angle α direction B*GPS antenna Height=Off track error direction B; and b.

(Off track error direction A+off track error direction B)/2=Off track error correction factor. c.

The off track error correction factor is then used to determine a calibrated roll angle α. If the GRU is offset from the longitudinal axis 28 and/or lateral axis 30, then the calibrated roll angle α is dependent upon the lateral offset distance and/or longitudinal offset distance, respectively.

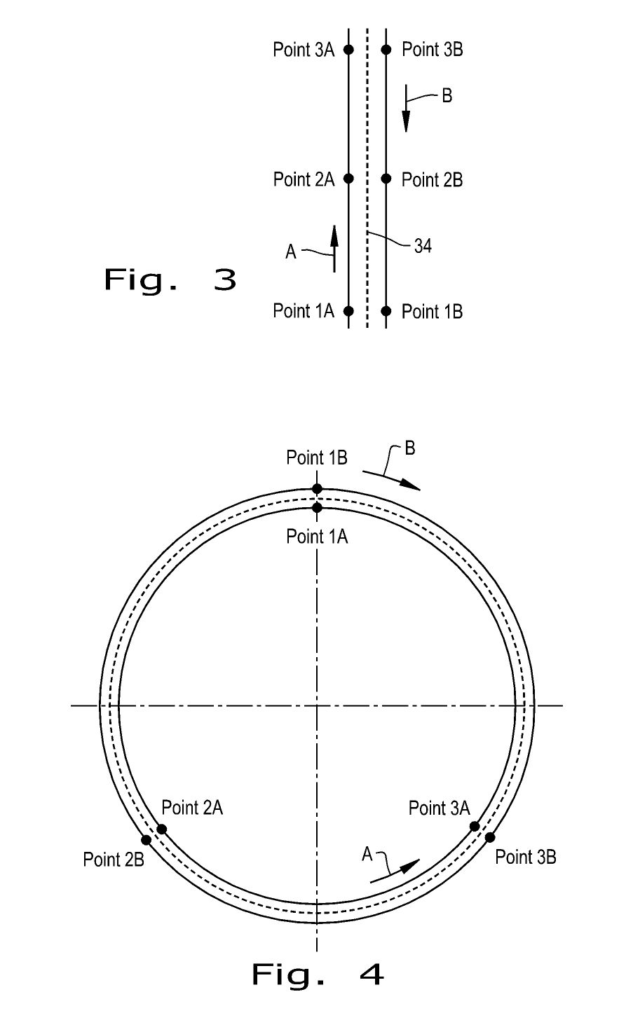

Referring now to FIG. 3, there is shown an overhead schematic representation of another embodiment of a sequence of calibration maneuvers (corresponding to a straight line) which can be used with the calibration method of the present invention. The first of the sequence of calibration maneuvers includes engaging an AG system of the vehicle 10 to travel in the first direction A along a known straight line 34 using the GRU 22. First calibration readings are then taken using the IMU 24 to measure a roll angle α of the vehicle 10 when the vehicle 10 is at points 1A, 2A and 3A while traveling in the direction A. The vehicle is then turned around and headed in a direction B which is opposite to direction A. The second of the sequence of calibration maneuvers includes engaging the AG system of the vehicle to travel in the opposite second direction B along the same known straight line using the GRU. Second calibration readings are then taken using the IMU 24 to measure a roll angle α of the vehicle 10 when the vehicle 10 is at points 3B, 2B and 1B while traveling in the direction B.

The first calibration readings and the second calibration readings are then reconciled to determine a calibrated roll angle of the vehicle. To that end, the sequence of calibration maneuvers can be represented with mathematical expressions:

Avg. roll angle α direction A*GPS antenna Height=Off track error direction A; a.

Avg. roll angle α direction B*GPS antenna Height=Off track error direction B; b.

(Off track error direction A+off track error direction B)/2=Off track error correction factor. c.

The off track error correction factor is then used to determine a calibrated roll angle α.

Referring now to FIG. 3, there is shown an overhead schematic representation of another embodiment of a sequence of calibration maneuvers (corresponding to a circle) which can be used with the calibration method of the present invention. The first of the sequence of calibration maneuvers includes engaging an AG system of the vehicle 10 to travel in the first direction A along a known circular path 36 using the GRU 22. First calibration readings are then taken using the IMU 24 to measure a roll angle α of the vehicle 10 when the vehicle 10 is at points 1A, 2A and 3A while traveling in the direction A. The vehicle is then turned around and headed in a direction B which is opposite to direction A. The second of the sequence of calibration maneuvers includes engaging the AG system of the vehicle to travel in the opposite second direction B along the same known straight line using the GRU. Second calibration readings are then taken using the IMU 24 to measure a roll angle α of the vehicle 10 when the vehicle 10 is at points 3B, 2B and 1B while traveling in the direction B.

The first calibration readings and the second calibration readings are then reconciled to determine a calibrated roll angle of the vehicle. To that end, the sequence of calibration maneuvers can be represented with mathematical expressions:

Avg. roll angle α direction A*GPS antenna Height=Off track error direction A; a.

Avg. roll angle α direction B*GPS antenna Height=Off track error direction B; b.

(Off track error direction A+off track error direction B)/2=Off track error correction factor. c.

The off track error correction factor is then used to determine a calibrated roll angle α.

In the calibration sequences described above, the sequences have the common factor of taking calibration readings while the vehicle 10 is in opposite directions. Examples of a point, line and circle are described. It is also possible that other calibration sequences can be used with the assistance of the AG system, such as an oval shaped travel path, etc.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of calibrating a roll angle associated with a work vehicle having a geo-reference unit (GRU) and an inertial measurement unit (IMU), the method comprising the steps of:
positioning the vehicle on a substantially level surface in a first direction;
taking a first calibration reading, by using the IMU to measure a roll of the vehicle while the vehicle is in a first of a sequence of calibration maneuvers in the first direction;
positioning the vehicle on the substantially level surface in a second direction, generally opposite the first direction;
taking a second calibration reading, by using the IMU to measure a roll of the vehicle while the vehicle is in a second of the sequence of calibration maneuvers in the second direction; and
reconciling the first calibration reading and the second calibration reading to determine a calibrated roll angle of the vehicle.

2. The work vehicle of claim 1, wherein the vehicle includes a longitudinal axis and the GRU is offset from the longitudinal axis by a lateral offset distance, and the calibrated roll angle is dependent upon the lateral offset distance.

3. The work vehicle of claim 1, wherein the vehicle includes a lateral axis which is perpendicular to the longitudinal axis, and the GRU is offset from the lateral axis by a longitudinal offset distance, and the calibrated roll angle is dependent upon the longitudinal offset distance.

4. The work vehicle of claim 1, wherein:
the first of the sequence of calibration maneuvers includes parking the vehicle in the first direction with the rear tires at a known reference location; and
the second of the sequence of calibration maneuvers includes parking the vehicle in the opposite second direction with the rear tires at the same known reference location.

5. The work vehicle of claim 4, wherein the sequence of calibration maneuvers can be represented with mathematical expressions:
Roll angle direction A*GPS antenna Height=Off track error direction A; a.
Roll angle direction B*GPS antenna Height=Off track error direction B; and b.
(Off track error direction A+off track error direction B)/2=Off track error correction factor. c.

6. The work vehicle of claim 1, wherein:
the first of the sequence of calibration maneuvers includes engaging an Auto Guidance (AG) system of the vehicle to travel in the first direction along a known straight line using the GRU; and
the second of the sequence of calibration maneuvers includes engaging the AG system of the vehicle to travel in the opposite second direction along the same known straight line using the GRU.

7. The work vehicle of claim 6, wherein the sequence of calibration maneuvers can be represented with the mathematical expressions:
Average roll angle direction A*GPS antenna Height=Off track error direction A; a.
Average roll angle direction B*GPS antenna Height=Off track error direction B; and b.
(Off track error direction A+off track error direction B)/2=Off track error correction factor. c.

8. The work vehicle of claim 1, wherein:
the first of the sequence of calibration maneuvers includes engaging an Auto Guidance (AG) system of the vehicle to travel in a first circular direction along a known circle using the GRU; and
the second of the sequence of calibration maneuvers includes engaging the AG of the vehicle to travel in an opposite second circular direction along the same known circle using the GRU.

9. The work vehicle of claim 8, wherein the sequence of calibration maneuvers can be represented with the mathematical expressions:
Average roll angle direction A*GPS antenna Height=Off track error direction A; a.
Average roll angle direction B*GPS antenna Height=Off track error direction B; and b.
(Off track error direction A+off track error direction B)/2=Off track error correction factor. c.

10. The work vehicle of claim 1, wherein the work vehicle is an agricultural work vehicle, an industrial work vehicle, a construction work vehicle or a forestry work vehicle.
